(19) United States
(12) Patent Application Publication
(10) Pub. No.: US 2023/0276254 A1
(43) Pub. Date: Aug. 31, 2023

(54) REFLECTION DIRECTION CONTROL SYSTEM, REFLECTION DIRECTION CONTROL DEVICE, REFLECTION DIRECTION CONTROL METHOD, AND REFLECTION DIRECTION CONTROL PROGRAM

(71) Applicant: NIPPON TELEGRAPH AND TELEPHONE CORPORATION, Tokyo (JP)

(72) Inventors: Masashi IWABUCHI, Musashino-shi, Tokyo (JP); Tomoaki OGAWA, Musashino-shi, Tokyo (JP); Tomoki MURAKAMI, Musashino-shi, Tokyo (JP); Riku OMIYA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/016,372

(22) PCT Filed: Jul. 20, 2020
(86) PCT No.: PCT/JP2020/028175

§ 371 Date: Jan. 16, 2023

(51) Int. Cl. H04W 16/26; H04W 16/28

(52) U.S. Cl. CPC H04W 16/26; H04W 16/28

(57) ABSTRACT

A reflection direction control system includes a reflection unit including a plurality of reflection elements, a direction estimation unit that estimates an incident direction of a radio wave transmitted by a base station to the reflection unit on the basis of base station position information indicating a preset position of the base station, a phase calculation unit that calculates a phase of the radio wave to be reflected by each of the plurality of reflection elements so that the reflection unit reflects the radio waves transmitted by the base station toward the wireless terminal on the basis of the position information of the wireless terminal received from the wireless terminal, and a phase control unit that controls the phase of the radio wave reflected by each of the plurality of reflection elements on the basis of the phase calculated phase calculation unit.

### TECHNICAL FIELD

The present invention relates to a reflection direction control system, a reflection direction control device, a reflection direction control method, and a reflection direction control program.

### BACKGROUND ART

To realize high speed and large capacity wireless access, using a high frequency band that can ensure a broad bandwidth draws attention. For example, high speed and large capacity are realized by using a 28 GHz band in a fifth generation mobile communication system and a 60 GHz band in IEEE 802.11ad (millimeter wave wireless LAN system) which is a wireless LAN standard.

In a high frequency band, radio waves are significantly attenuated compared with that in a low frequency band, and have radio properties of being less likely to be diffracted. Therefore, a high frequency band usage has problems that transmission distance is short and a reception quality is significantly deteriorated due to shielding.

In order to compensate the radio wave attenuation, beamforming is advantageous that uses a multi-element antenna in a transmitter station and a receiver station. By compensating the radio wave attenuation based on a beamforming gain, it is possible to increase the transmission distance.

In the beamforming, radio waves from a specific direction are strongly transmitted and received in both the transmitter station and the receiver station, and thus radio wave from one high-power path is mainly received by the receiver station. As a result, in the beamforming, the number of spatial multiplexing is kept as 1 (or 2 in the case of polarized multiplexing), and it is also difficult to achieve the space diversity effect by receiving the same signal.

On the other hand, to improve the deterioration of the reception quality caused by shielding or over-the-horizon, there is a method in which multiple antennas are installed. For example, by installing multiple transmission antennas, it is possible to reduce the range of shielding or over-the-horizon. It is also possible to solve the above-described problems in beamforming by installing multiple transmission antennas.

However, installing multiple transmission antennas causes problems that the network cost increases and the installation place becomes insufficient. In view of providing multiple transmission points, it is also advantageous to use reflectors and the like that are less expensive and have a smaller installation scale and less restrictions.

Conventionally, it is difficult to dynamically control the reflection characteristics. However, a reflector (dynamic reflector) that enables dynamic control of reflection characteristics using a metasurface or array element structure have been successfully developed, and thus it is possible to realize a method for achieving spatial multiplexing and the space diversity gain while using dynamic reflector to reduce a range of shielding or over-the-horizon (for example, see NPL 1, 2, 3).

As a method of controlling the dynamic reflector, there is a method of changing the characteristics of the radio wave by controlling the phase of the radio wave when the dynamic reflector reflects the radio wave. For example, there is a method of changing the phase of a radio wave reflected by a dynamic reflector composed of array elements on the basis of channel information (CSI: Channel State Information) between transmission and reception stations (for example, see NPL 3).

### CITATION LIST

### Non Patent Literature

[NPL 1] C. Liaskos, A. Tsioliaridou, A. Pitsillides, S. Ioannidis, and I. Akyildiz, “Using Any Surface to Realize a New Paradigm for Wireless Communications”, Communications of the ACM, November 2018, Vol. 61, No. 11, pp. 30-33
[NPL 2] E. Basar, M. D. Renzo, J. D. Rosny, M. Debbah, M-S Alouini, and R. Zhang, “Wireless Communications Through Reconfigurable Intelligent Surfaces”, IEEE Access, August 2019, Vol. 7, pp. 116753-116773
[NPL 3] Q. Wu, and R. Zhang, “Intelligent Reflecting Surface Enhanced Wireless Network via Joint Active and Passive Beamforming”, IEEE transaction on wireless communications, November 2019, vol. 18, No. 11, pp. 5394-5409

### SUMMARY OF INVENTION

### Technical Problem

However, in the conventional system based on channel information between the transmission and reception stations, the characteristics of the reception station can be optimized, but channel information for each array element through which radio waves pass is required. For example, when the dynamic reflector is composed of 100 array elements, it is necessary to calculate the amount of phase change based on 100 channel information.

In other words, large overhead occurs in order to obtain channel information. In addition, since it is considered that a certain calculation resource is necessary to calculate the amount of phase change of each array element, it is assumed that the amount of phase change is calculated on the base station side. In this case, quality improvement by the dynamic reflector cannot be realized unless the base station has a new function.

It is also assumed that the base station and the dynamic reflector are installed at a remote place. Therefore, in the conventional method, a communication means for reflecting the amount of phase change calculated by the base station on the dynamic reflector is required, and the dynamic reflector also needs a function for cooperating with the base station.

The present invention has been made in view of the above-mentioned problems, and is provided with a reflection direction control system, a reflection direction control device, a reflection direction control method, and a reflection direction control program.

### Solution to Problem

A reflection direction control system according to an aspect of the present invention includes a reflection unit including a plurality of reflection elements, a direction estimation unit that estimates an incident direction of radio waves transmitted by a base station to the reflection unit on the basis of base station position information indicating a preset position of the base station, a phase calculation unit that calculates a phase of radio wave to be reflected by each of the plurality of reflection elements so that the reflection unit reflects the radio waves transmitted by the base station toward the wireless terminal on the basis of the incident direction of the radio waves estimated by the direction estimation unit and the position information of the wireless terminal received from the wireless terminal, and a phase control unit that controls the phase of the radio wave reflected by each of the plurality of reflection elements on the basis of the phase calculated by the phase calculation unit.

A reflection direction control device according to an aspect of the present invention includes a direction estimation unit that estimates an incident direction of radio waves transmitted by a base station to a reflection unit including a plurality of reflection elements on the basis of base station position information indicating a preset position of the base station, a phase calculation unit that calculates a phase of the radio wave to be reflected by each of the plurality of reflection elements so that the reflection unit reflects the radio waves transmitted by the base station toward the wireless terminal on the basis of the incident direction of the radio waves estimated by the direction estimation unit and the position information of the wireless terminal received from the wireless terminal, and a phase control unit that controls the phase of the radio wave reflected by each of the plurality of reflection elements on the basis of the phase calculated by the phase calculation unit.

A reflection direction control method according to an aspect of the present invention includes a direction estimation step of estimating an incident direction of radio waves transmitted by a base station to a reflection unit including a plurality of reflection elements on the basis of base station position information indicating a preset position of the base station, a phase calculation step of calculating a phase of the radio waves to be reflected by each of the plurality of reflection elements so that the reflection unit reflects the radio waves transmitted by the base station toward the wireless terminal on the basis of the estimated incident direction of the radio waves and the position information of the wireless terminal received from the wireless terminal, and a phase control step of controlling the phase of the radio wave reflected by each of the plurality of reflection elements on the basis of the calculated phase.

### Advantageous Effects of Invention

According to the present invention, the reflection direction of the radio waves can be dynamically controlled with a small amount of calculation.

### BRIEF DESCRIPTION OF DRAWINGS

FIG. 1 is a diagram showing a configuration of a wireless communication system according to an embodiment of the present invention.

FIG. 2 is a functional block illustrating functions of a wireless terminal.

FIG. 3 is a functional block exemplifying functions of a reflection direction control system according to the embodiment.

FIG. 4 is a diagram schematically showing the relationship between an incident direction and a reflection direction of the radio waves to the reflection unit and an installation direction of the reflection unit.

FIG. 5 is a sequence diagram showing an example of operation of the wireless communication system with a reflection direction control system.

FIG. 6 is a diagram showing an example of a hardware configuration of the reflection direction control device according to the embodiment.

FIG. 7 is a diagram showing a comparative example of a configuration of a wireless communication system including a dynamic reflector.

### DESCRIPTION OF EMBODIMENTS

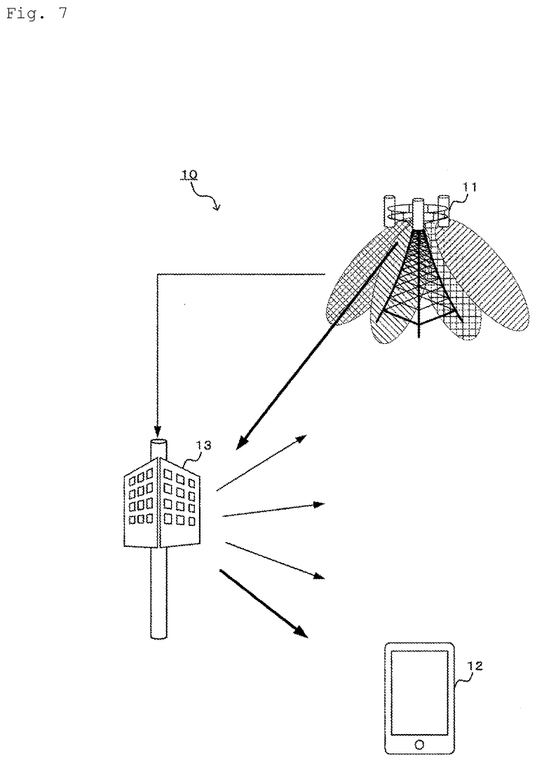

In the description of the reflection direction control system according to the embodiment, the background that the present invention has been achieved will be first described. FIG. 7 is a diagram showing a comparative example of a configuration of a wireless communication system 10 including a dynamic reflector.

In the wireless communication system 10, a dynamic reflector 13 having a plurality of reflection elements reflects and relays radio waves in order to perform wireless communication between a base station 11 and a wireless terminal 12. At this time, the base station 11 acquires channel information (CSI Channel State Information) for all of a plurality of reflection elements included in the dynamic reflector 13, and adjusts a phase of radio waves reflected by the dynamic reflector 13.

Therefore, in addition to a general base station function, the base station 11 needs an advanced signal processing function for acquiring and processing channel information for all of the plurality of reflection elements, and a function for notifying the dynamic reflector 13 of information on a phase for changing reflection characteristics.

That is, the base station 11 increases the overhead for acquiring channel information, and when the number of reflection elements is large, the amount of calculation for dynamically controlling the phase of the radio waves reflected by the dynamic reflector 13 becomes enormous.

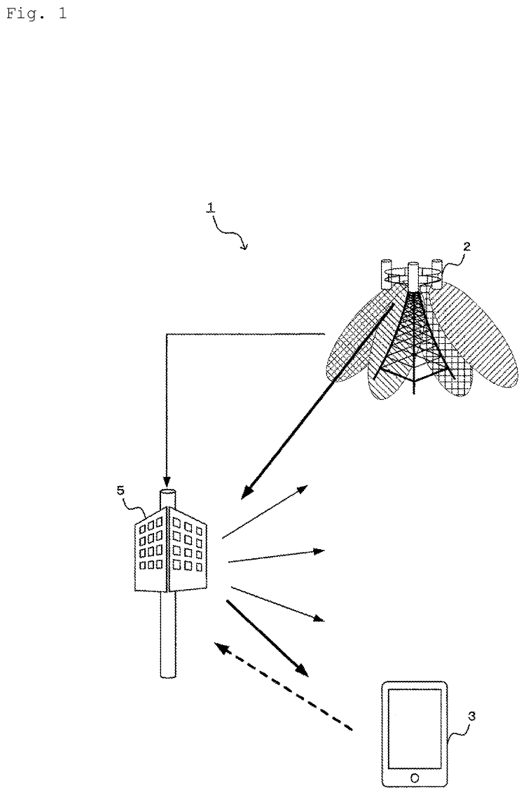

Next, a wireless communication system including a reflection direction control system according to the embodiment will be described. FIG. 1 is a diagram showing a configuration of a wireless communication system 1 according to the embodiment of the present invention. As shown in FIG. 1, the wireless communication system 1 is configured such that, for example, one or more base stations 2 and one or more wireless terminals 3 perform wireless communication via a reflection direction control system 5.

The reflection direction control system 5 relays signals transmitted by the base station 2 to each of the wireless terminals 3 and relays signals transmitted by each of the wireless terminals 3 to the base station 2 by controlling a dynamic reflector having a plurality of reflection elements. The wireless terminal 3 has a function of measuring (positioning) the position of its own station, and transmits position information indicating the measured position of its own station to the reflection direction control system 5.

The reflection direction control system 5 estimates an incident direction of radio waves transmitted by the base station 2 to the dynamic reflector on the basis of base station position information indicating a preset position of the base station 2. Further, the reflection direction control system 5 calculates a phase of the radio wave to be reflected by each of the plurality of reflection elements so that the radio waves transmitted by the base station 2 are reflected to the wireless terminal 3 on the basis of the estimated incident direction of the radio waves and the position information of the wireless terminal 3 received from the wireless terminal 3. The reflection direction control system 5 controls the phase of the radio wave reflected by each of the plurality of reflection elements on the basis of the calculated phase.

That is, the reflection direction control system 5 can dynamically control the reflection direction of the radio waves without using channel information for all of the plurality of reflection elements and without having an advanced signal processing function for processing channel information for all of the reflection elements. Although the reflection direction control system 5 is described by taking a case where the phase of the radio wave is dynamically controlled as an example, it may be configured as a relay device for relaying the radio waves by a repeater having a power amplifier. The reflection direction control system 5 may dynamically control the reflection direction of the radio waves at an arbitrarily set timing.

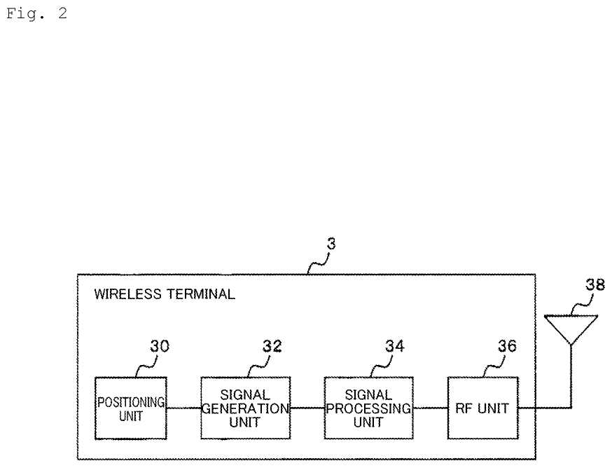

Hereinafter, the configuration of the wireless communication system 1 will be described. FIG. 2 is a functional block diagram of the wireless terminal 3. As shown in FIG. 2, the wireless terminal 3 includes, for example, a positioning unit 30, a signal generation unit 32, a signal processing unit 34, an RF unit 36 and an antenna unit 38.

The positioning unit 30 measures (or estimates) the position of the wireless terminal 3, and outputs position information indicating the position of the wireless terminal 3 to the signal generation unit 32. For example, the positioning unit 30 measures (positions) the position of the wireless terminal 3 using a signal of the wireless communication system 1 (for example, a cellular system) used for communication between the base station 2 and the wireless terminal 3. At this time, the positioning unit 30 performs positioning by using signals received from the plurality of base stations 2.

Further, the positioning unit 30 may use a signal of a wireless communication system (for example, Wi-Fi (trademark), Bluetooth (trademark)) different from a signal of the wireless communication system 1 used for communication between the base station 2 and the wireless terminal 3. Further, the positioning unit 30 may position the position of itself by a GPS (Global Positioning System, not shown), or may position the position of itself by some sensors (for example, a gyro sensor, an atmospheric pressure sensor, a camera, a laser, an infrared ray, and a LiDAR). The positioning unit 30 may perform positioning by a combination of a plurality of methods.

The signal generation unit 32 generates a notification signal including position information input from, for example, the positioning unit 30, and outputs the generated notification signal to the signal processing unit 34. The notification signal may include an identification signal of the wireless terminal 3 and information on communication quality with the base station 2 measured by the wireless terminal 3 in addition to the position information of the wireless terminal 3 input from the positioning unit 30. The signal generation unit 32 may generate the notification signal at a preset period, or may generate the notification signal when the communication quality with the base station 2 measured by the wireless terminal 3 becomes equal to or less than a predetermined value.

The signal processing unit 34 modulates the notification signal into a radio signal in the wireless communication system 1 in order to transmit the notification signal input from the signal generation unit 32, and outputs the modulated radio signal to the RF unit 36. The signal processing unit 34 has a function of demodulating the signal received via the antenna unit 38 and the RF unit 36.

The RF unit 36 performs necessary processing for converting the transmission signal modulated by the signal processing unit 34 into a predetermined radio wave and transmitting it, or performing signal processing, by the signal processing unit 34, for the radio waves received by the antenna unit 38. For example, the RF unit 36 performs signal amplification, down conversion from a system band, or up conversion to a system band, and filtering or the like.

The antenna unit 38 transmits and receives the notification signal and the radio signal related to the notification signal between the reflection direction control system 5 and the base station 2.

The wireless terminal 3 may transmit the notification signal including the position information in a same frequency band as the other transmission signals or in a different frequency band. For example, the wireless terminal 3 may use a high frequency band in communication with the base station 2, and may use a low frequency band in transmission of the notification signal. Thus, the wireless terminal 3 avoids difficulty in reaching radio waves in a high frequency band in transmission of the notification signal, and easily transmits the notification signal to the reflection direction control system 5.

The notification signal may be any of a broadcast signal, a multicast signal, and a unicast signal. Further, the wireless terminal 3 may transmit the notification signal by using a wireless communication system (for example, Wi-Fi (trademark), Bluetooth (trademark)) different from a signal of the wireless communication system 1 used for communication with the base station 2. In this case, the wireless terminal 3 may establish a link with the reflection direction control system 5 and transmit a multicast signal or a unicast signal to the reflection direction control system 5 by using the established link.

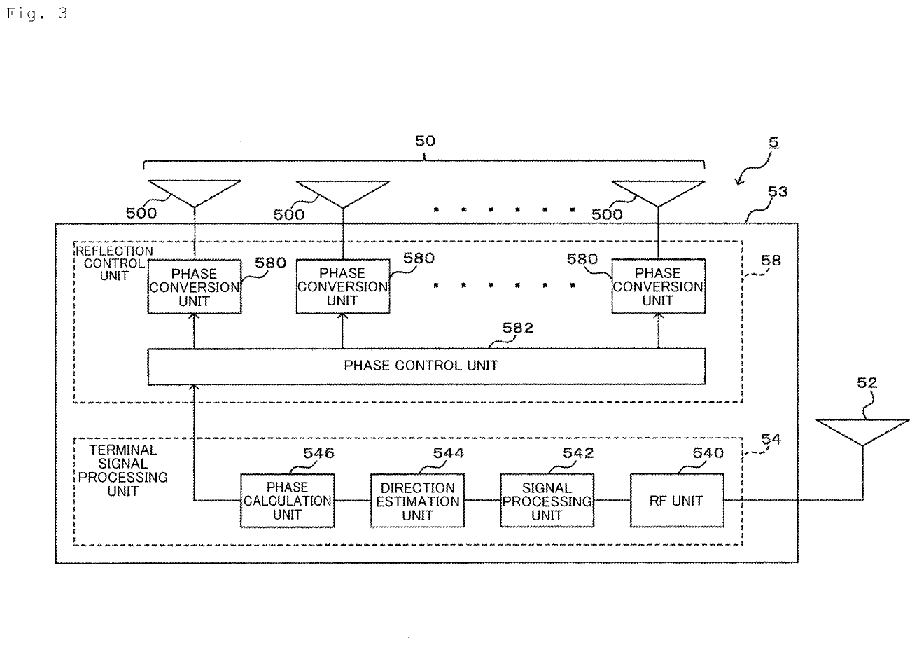

FIG. 3 is a functional block illustrating functions of the reflection direction control system 5 according to the embodiment. As shown in FIG. 3, the reflection direction control system 5 includes, for example, a reflection unit 50, an antenna unit 52, and a reflection direction control device 53.

The reflection unit 50 includes a plurality of reflection elements 500 and, for example, is a dynamic reflector in which the plurality of reflection elements 500 are arranged in an array. The reflection element 500 reflects the radio waves transmitted by the base station 2 and the radio waves transmitted by the wireless terminal 3 according to control of the reflection direction control device 53. For example, the reflection element 500 is a so-called metamaterial, and has a characteristic of shifting a phase when reflecting a radio wave.

The antenna unit 52 transmits and receives radio waves to and from the wireless terminal 3. Specifically, the antenna unit 52 receives the radio wave (wireless signal) transmitted by the wireless terminal 3, outputs the received signal (notification signal or the like) to the reflection direction control device 53, and transmits the signal output by the reflection direction control device 53 to the wireless terminal 3.

The reflection direction control device 53 includes, for example, a terminal signal processing unit 54 and a reflection control unit 58, and controls each of the reflection elements 500 on the basis of the notification signal transmitted by the wireless terminal 3.

The terminal signal processing unit 54 includes an RF unit 540, a signal processing unit 542, a direction estimation unit 544, and a phase calculation unit 546.

The RF unit 540 performs signal processing necessary for the signal processing unit 542 to perform digital signal processing on the radio waves received by the antenna unit 52. The RF unit 540 performs processing necessary for converting the transmission signal processed by the signal processing unit 542 into a predetermined radio wave and transmitting the radio wave. For example, the RF unit 540 performs signal amplification, down-conversion from a system band, or up-conversion to a system band, and filtering or the like.

The signal processing unit 542 has a function of demodulating a radio signal including the notification signal, and extracts an identification signal for identifying the wireless terminal 3 from the demodulated signal and outputs the extracted identification signal to the direction estimation unit 544, for example. In order to transmit the radio signal, the signal processing unit 542 modulates a control signal used for wireless communication with the wireless terminal 3, for example, and outputs the modulated control signal to the RF unit 540.

The direction estimation unit 544 estimates, for example, an incident direction of radio waves transmitted by the base station 2 to the reflection unit 50 on the basis of base station position information indicating a preset position of the base station 2 and a preset position and installation direction of the reflection unit 50, and outputs the estimated incident direction to the phase calculation unit 546.

The direction estimation unit 544 may set the position and installation direction of the reflection unit 50 when the reflection direction control system 5 is installed. The reflection direction control system 5 may have a function of measuring its own position and installation direction, and the direction estimation unit 544 may acquire the position and installation direction of the reflection unit 50 by the function.

The direction estimation unit 544 may be configured to estimate an incident direction and a reflection direction (incident angle and reflection angle) to the reflection unit 50 of the radio waves transmitted by the base station 2 and an incident direction and a reflection direction (incident angle and reflection angle) to the reflection unit 50 of the radio waves transmitted by the wireless terminal 3.

For example, the direction estimation unit 544 may estimate the reflection direction of the radio waves transmitted by the wireless terminal 3 by the reflection unit 50 on the basis of position information of the wireless terminal 3 included in the notification signal transmitted by the wireless terminal 3 and the position and installation direction of the reflection unit 50.

The direction estimation unit 544 may have a function of estimating the arrival direction of the radio waves, or may be configured to perform calibration using the signal periodically transmitted from the base station 2 to estimate the incident angle.

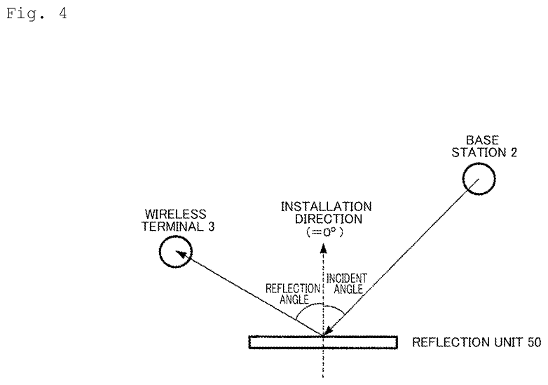

FIG. 4 is a diagram schematically showing the relationship between the incident direction and the reflection direction of the radio wave to the reflection unit 50 and the installation direction of the reflection unit 50. In FIG. 4, the incident direction and the reflection direction of the radio wave during the downlink transmission are shown, but in the uplink transmission, the incident direction and the reflection direction are reversed, and the incident angle and the reflection angle are replaced with each other. Here, it is assumed that the direction estimation unit 544 acquires information indicating the position and the installation direction of the reflection unit 50 in advance.

The reflection direction control system 5 may measure the position of the reflection unit 50 by a GPS (Global Positioning System), or may measure the installation direction and inclination of the reflection unit 50 by using a gyro sensor. Then, the reflection direction control system 5 sequentially updates and stores the measurement result.

The direction estimation unit 544 may acquire direction information indicating a direction from the reflection unit 50 to the base station 2 in advance. For example, the direction estimation unit 544 may acquire direction information indicating a direction from the reflection unit 50 to the base station 2 when the reflection direction control system 5 is installed, or may estimate the direction information on the basis of the position of the base station 2 and the position of the reflection unit 50.

Further, the reflection direction control system 5 may estimate the position of the base station 2 and calculate the direction from the reflection unit 50 to the base station 2 by using the previously acquired position information and installation direction of the reflection unit 50.

As described above, the direction estimation unit 544 may estimate the incident angle shown in FIG. 4 by using the direction information indicating the direction from the reflection unit 50 to the base station 2. The direction estimation unit 544 may estimate the reflection angle shown in FIG. 4 by using the position information of the wireless terminal 3 received from the wireless terminal 3 and the position information and the installation direction of the reflection unit 50 acquired by the above method.

The direction estimation unit 544 may estimate the direction from the reflection unit 50 to the wireless terminal 3 with respect to the installation direction of the reflection unit 50 as a reflection angle for reflecting the radio wave from the base station 2 during the downlink transmission. The direction estimation unit 544 may estimate the direction from the wireless terminal 3 to the reflection unit 50 with respect to an installation direction of the reflection unit 50 as an incident angle at which the radio wave from the wireless terminal 3 is made incident during uplink transmission.

The phase calculation unit 546 calculates a phase of the radio wave to be reflected by each of the plurality of reflection elements 500 so that the reflection unit 50 reflects the radio waves transmitted by the base station 2 toward the wireless terminal 3 on the basis of the incident direction of the radio waves estimated by the direction estimation unit 544 and the position information received from the wireless terminal 3. Then, the phase calculation unit 546 outputs information indicating the calculated phase to the reflection control unit 58. Here, the phase calculation unit 546 calculates the phase of the radio waves by using the incident angle and the reflection angle (incident direction and reflection direction) shown in FIG. 4.

Further, the phase calculation unit 546 may refer to the position information of the plurality of wireless terminals 3 instead of the direction from the reflection unit 50 to the wireless terminal 3, and calculate the phase of the radio waves so that the reflection unit 50 performs beam forming in the direction to the position where the largest number of wireless terminals 3 are likely to exist.

For example, the phase calculation unit 546 may calculate the mutual distance between the wireless terminals 3 by using the position information of the plurality of wireless terminals 3, and cluster the plurality of wireless terminals 3 whose mutual distance between the wireless terminals 3 is equal to or less than a predetermined value.

Further, the phase calculation unit 546 obtains a position centroid point of the wireless terminal 3 in the cluster from the position information of each wireless terminal 3 in the cluster, instead of the direction from the reflection unit 50 to the wireless terminal 3, may use the direction from the reflection unit 50 to the position centroid point of the wireless terminals 3.

That is, the phase calculation unit 546 may calculate the phase of the radio wave to be reflected by each of the plurality of reflection elements 500 so that the reflection unit 50 reflects the radio waves made incident from a predetermined direction toward a cluster composed of a plurality of wireless terminals 3 satisfying a predetermined condition.

The phase calculation unit 546 may calculate the phase of the radio wave to be reflected by each of the plurality of reflection elements 500 for each reflection unit 50 on the basis of a predetermined priority.

When one reflection unit 50 reflects radio waves transmitted by the plurality of wireless terminals 3, the phase calculation unit 546 divides the plurality of reflection elements 500 into a plurality of reflection element groups and calculate the phase of the radio wave to be reflected by each reflection element 500 so that the radio wave is reflected to the different wireless terminal 3 for each reflection element group.

The reflection control unit 58 includes a plurality of phase conversion units 580 and a phase control unit 582 for controlling each of the phase conversion units 580. The phase conversion unit 580 is provided individually for each of the reflection elements 500, for example, and performs conversion for changing the phase of the radio wave reflected by the reflection element 500 according to control from the phase control unit 582. The phase control unit 582 controls each of the phase conversion units 580 on the basis of the phase calculated by the phase calculation unit 546.

For example, the phase control unit 582 controls each of the plurality of phase conversion units 580 so that the phases of the radio wave reflected by each of the plurality of reflection elements 500 are shifted little by little on the basis of the phase calculated by the phase calculation unit 546. For example, when the reflection element 500 is the meta-material described above, the phase conversion unit 580 changes the characteristics of the reflection element 500 in accordance with the control of the phase control unit 582, thereby dynamically changes the phase shift amount by the reflection element 500. In this way, the phase control unit 582 controls the phase of the meta-material by the characteristic change of the meta-material, the multiplication of the phase change amount, and adding a predetermined delay or the like, so that the reflection unit 50 performs beam forming in a predetermined direction.

When the controllable phase amount to the reflection element 500 is discrete, the phase control unit 582 selects a phase amount closest to the phase (phase change amount) calculated by the phase calculation unit 546 from among settable phase amounts, and controls each of the plurality of phase conversion units 580.

Further, the phase control unit 582 may be configured to control each of the plurality of reflection elements 500 on the basis of the incident direction and the reflection direction (incident angle and reflection angle) estimated by the direction estimation unit 544. For example, when the phase control unit 582 is designed as a mode in which a controllable value is limited in advance and fixed, the direction estimation unit 544 may calculate an optimum mode using the estimated incident angle and reflection angle, and output the calculated mode information to the phase control unit 582.

Further, the phase control unit 582 may perform control so as to determine the priority of the plurality of wireless terminals 3, for example, as shown by the following (1) to (5).

### (1) [Prioritizing Wireless Terminal 3 on the Basis of Received Power]

The wireless terminal 3 is more likely to receive the benefit from the reflection direction control system 5 as the distance from the reflection direction control system 5 is shorter. When the wireless terminal 3 having a long distance from the reflection direction control system 5, that is, the wireless terminal 3 having a small received power is given priority, many reflection direction control systems 5 arranged in the periphery respond to the same wireless terminal 3, and more reflection direction control systems 5 than necessary can be used for a single wireless terminal 3.

Then, the phase control unit 582 lists the wireless terminals 3 in the descending order of the received power measured by the reflection direction control system 5, and determines the direction of the wireless terminal 3 having the larger received power as the reflection direction by giving priority to the direction. The phase control unit 582 updates the list every time the measurement result is received from the wireless terminal 3.

### (2) [Prioritizing on the Basis of Quality Information of Wireless Terminal 3 Added to Transmission Signal]

The wireless terminal 3 can add the quality information measured by itself to the transmission signal (notification signal). When receiving the notification signal, the reflection direction control system 5 confirms the quality information, creates a list in which the wireless terminals 3 with poor quality are arranged in order, and determines the direction of the wireless terminals 3 with poor quality as the reflection direction by giving priority to the direction. The phase control unit 582 updates the list every time the measurement result is received from the wireless terminal 3.

### (3) [Prioritizing Wireless Terminal 3 on the Basis of Estimated Direction or Position]

The direction estimation unit 544 estimates a direction to be reflected to each of the wireless terminals 3 on the basis of the position information of each of the wireless terminals 3, for example.

When the reflection direction control system 5 receives the notification signals from the plurality of wireless terminals 3, the phase control unit 582 groups the wireless terminals 3 whose directions or positions are the same or almost the same. Further, the phase control unit 582 may take a difference in the estimation direction with respect to the two wireless terminals 3, and associate the two wireless terminals 3 as the same group when the difference is equal to or less than a predetermined value. In this case, the phase control unit 582 groups the combinations of all the wireless terminals 3.

Also, when grouping the wireless terminals 3 on the basis of the positions of the wireless terminals 3, the phase control unit 582 may calculate the distance between the wireless terminals 3 on the basis of the position information notified from the two wireless terminals 3, and associate the two wireless terminals 3 as the same group when the calculated distance is equal to or less than a predetermined value.

Further, the phase control unit 582 may determine the direction of a group having a large number of wireless terminals 3 as the reflection direction after the grouping processing. At this time, the phase control unit 582 may use the direction estimated for the representative wireless terminal 3 selected arbitrarily in the group, may use the average value of the estimated directions of all the wireless terminals 3 in the group, or may use the direction of the wireless terminal 3 located in the direction closest to the average value.

Further, when using the position of the wireless terminal 3, the phase control unit 582 may apply the position of the representative wireless terminal 3 selected arbitrarily in the group, the centroid point of the positions of all the wireless terminals 3 in the group, and the direction to the position of the wireless terminal 3 closest to the centroid point.

### (4) [Prioritizing Wireless Terminal 3 on the Basis of Position of Wireless Terminal 3]

The phase control unit 582 calculates the distance between the wireless terminal 3 and the reflection direction control system 5 by using the position information of the wireless terminal 3 which can be acquired from the notification signal and the position information of the reflection direction control system 5 itself, lists the wireless terminals 3 in the order of the shorter calculated distance, and preferentially sets the direction of the wireless terminal 3 having the shorter distance as the reflection direction. The phase control unit 582 updates the list every time the measurement result is received from the wireless terminal 3.

### (5) [Prioritizing Wireless Terminal 3 on the Basis of Combinations]

The phase control unit 582 lists priorities on the basis of a combination of two or more of received power, quality information, an estimation direction or a position on the basis of the above-mentioned method of (1) to (4) and may set the reflection direction.

Further, when receiving notification signals from the plurality of wireless terminals 3, the reflection direction control system 5 may control the phase so that one reflection direction control system 5 can reflect in a plurality of reflection directions by dividing a plurality of reflection elements 500 included in the reflection direction control system 5 and controlling a reflection direction for each of the divided reflection element groups.

For example, when receiving the notification signals from the four wireless terminals 3, the reflection direction control system 5 having N reflection elements 500 may control the reflection direction so as to reflect the radio waves in the directions of the respective wireless terminals 3 by using the N/4 reflection elements 500 for each wireless terminal 3. In this case, although the gain after reflection decreases, the communication quality of the plurality of wireless terminals 3 can be improved at the same time.

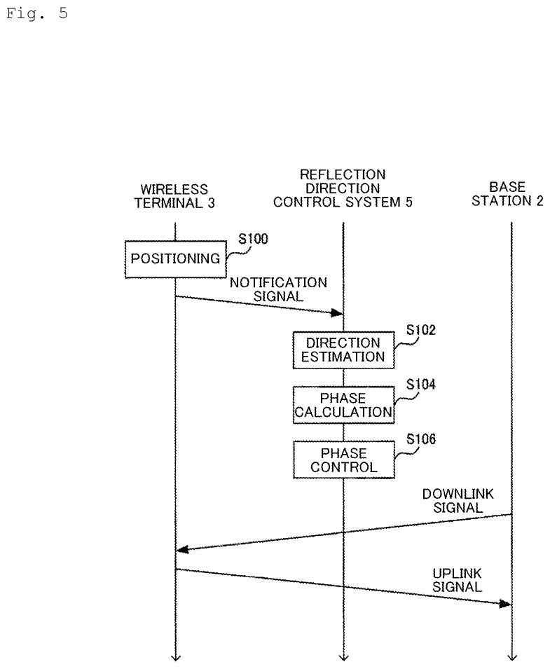

Next, an example of operation of the wireless communication system 1 having the reflection direction control system 5 will be described. FIG. 5 is a sequence diagram showing an example of the operation of the wireless communication system 1 having the reflection direction control system 5.

First, the wireless terminal 3 measures its own position (S100), and transmits a notification signal including its own position information to the reflection direction control system 5.

The reflection direction control system 5 estimates an incident direction of the radio waves transmitted by the wireless terminal 3 to the reflection unit 50 on the basis of the position information received from the wireless terminal 3 (S102).

Next, each reflection direction control system 5 calculates a phase of the radio wave to be reflected by each of the plurality of reflection elements 500 so that the reflection unit 50 reflects the radio wave made incident in the estimated direction toward the base station 2 (S104).

Then, each reflection direction control system 5 performs phase control (reflection direction control) of radio wave reflected by each of the plurality of reflection elements 500 (S106). Thereafter, the wireless terminal 3 and the base station 2 mutually perform communication (uplink signals and downlink signals).

In this way, the reflection direction control system 5 controls the phase of the radio wave reflected by each reflection element 500 on the basis of the position information received from the wireless terminal 3, so that the reflection direction of the radio waves can be dynamically controlled with a small calculation amount. Further, since the reflection direction control system 5 controls the phase of the radio wave reflected by each reflection element 500 when the radio wave arrives, the coverage by the base station 2 can be expanded.

The functions of the reflection direction control system 5 (or the reflection direction control device 53) may be partially or entirely constituted by hardware such as PLD (Programmable Logic Device) and FPGA (Field Programmable Gate Array), or may be constituted as a program to be executed by a processor such as a CPU.

For example, the reflection direction control device 53 according to the present invention can be realized using a computer and a program, and the program can be recorded on a storage medium or provided through a network.

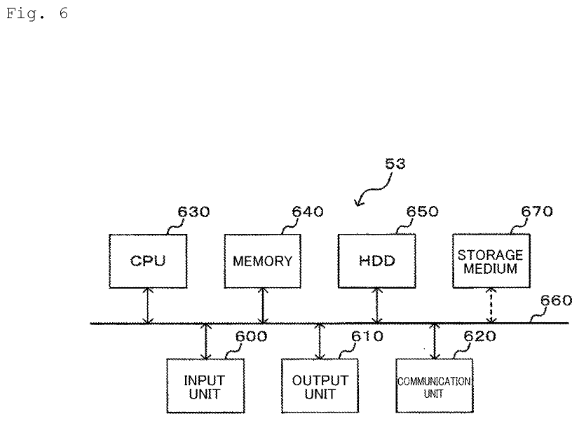

FIG. 6 is a diagram showing an example of the hardware configuration of the reflection direction control device 53 according to the embodiment. As shown in FIG. 6, for example, the reflection direction control device 53 includes an input unit 600, an output unit 610, a communication unit 620, a CPU 630, memory 640, and an HDD 650 which are connected through a bus 660, and the function as a computer. The reflection direction control device 53 can input and output data to and from the computer-readable storage medium 670.

The input unit 600 is, for example, a keyboard, a mouse, or the like. The output unit 610 is, for example, a display device such as a display. The communication unit 620 is, for example, a wireless network interface.

The CPU 630 controls each unit constituting the reflection direction control device 53 as described above, and performs predetermined processing or the like. The memory 640 and the HDD 650 are storage units for storing data or the like.

The storage medium 670 can store a program or the like for executing functions of the reflection direction control device 53. The architecture constituting the reflection direction control device 53 is not limited to the example shown in FIG. 6.

It is assumed that a “computer system” as used herein includes an OS and hardware such as peripheral devices. In addition, a “computer-readable storage medium” refers to a storage medium such as a portable medium such as a flexible disk, a magneto-optical disk, a ROM, or a CD-ROM.

Furthermore, a “computer-readable storage medium” may also include a part that dynamically holds a program for a short amount of time like a network such as the Internet or like a communication line used in the case of transmitting a program via a communication line such as a telephone line or a part that holds the program for a certain time such as a volatile memory inside a server or computer that serves as a client in such a case.

Although embodiments of the present invention were described above with reference to the drawings, it is clear that the above-described embodiments are merely exemplary illustrations of the present invention and the present invention is not limited to the above-described embodiments. Accordingly, additions, omissions, substitutions, and other modifications of the components may be made within a scope that does not depart from the technical spirit and scope of the present invention.

### REFERENCE SIGNS LIST

1 Wireless communication system
2 Base station
3 Wireless terminal
5 Reflection direction control system
30 Positioning unit
32 Signal generation unit
34 Signal processing unit
36 RF unit
38 Antenna unit
50 Reflection unit
52 Antenna unit
53 Reflection direction control device
54 Terminal signal processing unit
58 Reflection control unit
500 Reflection element
540 RF unit
542 Signal processing unit
544 Direction estimation unit
546 Phase calculation unit
580 Phase conversion unit
582 Phase control unit
600 Input unit
610 Output unit
620 Communication unit
630 CPU
640 Memory
650 HDD
660 Bus
670 Storage medium

1. A reflection direction control system comprising:
a reflection unit including a plurality of reflection elements;
a direction estimation unit configured to estimate an incident direction of radio waves transmitted by the base station to the reflection unit on the basis of base station position information indicating a preset position of the base station;
a phase calculation unit configured to calculate a phase of the radio wave to be reflected by each of the plurality of reflection elements so that the reflection unit reflects the radio waves transmitted by the base station toward the wireless terminal on the basis of the incident direction of the radio waves estimated by the direction estimation unit and the position information of the wireless terminal received from the wireless terminal; and
a phase control unit configured to control the phase of the radio wave reflected by each of the plurality of reflection elements on the basis of the phase calculated by the phase calculation unit.

2. The reflection direction control system according to claim 1, wherein
the phase calculation unit calculates the phase of the radio wave to be reflected by each of the plurality of reflection elements so that the reflection unit reflects the radio waves transmitted by the base station toward a cluster composed of a plurality of wireless terminals satisfying a predetermined condition.

3. The reflection direction control system according to claim 1, wherein,
the phase calculation unit calculates the phase of the radio wave to be reflected by each of the plurality of reflection elements for each reflection unit on the basis of predetermined priority.

4. The reflection direction control system according to claim 1, wherein,
the phase calculation unit, when one reflection unit reflects radio waves transmitted by a plurality of wireless terminals, divides the plurality of reflection elements into a plurality of reflection element groups, and calculate the phase of the radio wave to be reflected by each reflection element so as to reflect the radio waves toward different wireless terminals for each reflection element group.

5. A reflection direction control device comprising:
a direction estimation unit configured to estimate an incident direction of radio waves transmitted by a base station to a reflection unit including a plurality of reflection elements on the basis of base station position information indicating a preset position of the base station;
a phase calculation unit configured to calculate a phase of the radio wave to be reflected by each of the plurality of reflection elements so that the reflection unit reflects the radio waves transmitted by the base station toward the wireless terminal on the basis of the incident direction of the radio wave estimated by the direction estimation unit and the position information of the wireless terminal received from the wireless terminal; and
a phase control unit configured to control the phase of the radio wave reflected by each of the plurality of reflection elements on the basis of the phase calculated by the phase calculation unit.

6. A reflection direction control method comprising:
estimating an incident direction of radio waves transmitted by a base station to a reflection unit including a plurality of reflection elements on the basis of base station position information indicating a preset position of the base station;
calculating a phase of the radio wave to be reflected by each of the plurality of reflection elements so that the reflection unit reflects the radio waves transmitted by the base station toward the wireless terminal on the basis of the estimated incident direction of the radio wave and positional information of the wireless terminal received from the wireless terminal; and
controlling the phase of the radio wave reflected by each of the plurality of reflection elements on the basis of the calculated phase.

7. A non-transitory computer-readable storage medium storing a reflection direction control program for enabling a computer to function as each unit of the reflection direction control device according to claim 5.
